(19) United States
(12) Patent Application Publication
(10) Pub. No.: US 2007/0204793 A1
(43) Pub. Date: Sep. 6, 2007

(54) Nozzle And Filter Arrangement And System For Applying A Fluid Containing Solid Particles To A Substrate

(76) Inventors: Hubert Kufner, Luneburg (DE); Uwe Weddehage, Luneburg (DE); Thomas Burmester, Bleckede (DE)

Correspondence Address: WOOD, HERRON & EVANS, LLP (NORDSON), 2700 CAREW TOWER, 441 VINE STREET, CINCINNATI, OH, 45202, US

(21) Appl. No.: 10/568,025

(22) PCT Filed: Aug. 12, 2004
(86) PCT No.: PCT/EP04/09016

§ 371 Date: Oct. 4, 2006

(30) Foreign Application Priority Data
Aug. 14, 2003 (DE) 103 37 768.9

(51) Int. Cl. B05C 19/00

(52) U.S. Cl. 118/308; 118/324

(57) ABSTRACT

The invention relates to a system for applying a fluid (118) containing solid particles. Said system comprises a nozzle arrangement (110) and a transport device (150). The angle formed between the transport direction (130) of the transport device (150) and an outflow channel (124) of the nozzle arrangement (110, 210, 310, 410) is obtuse. The invention also relates to the nozzle arrangement (110) and a filter arrangement (570) for one such system. Said nozzle arrangement (110) comprises an endpiece receiving element (112) and an endpiece (114) which is fixed thereto. A fluid channel is formed in the nozzle arrangement (110), said fluid channel comprising a connection channel (120), an adjacent distribution channel (122), and an adjacent outflow channel (124). The connection channel (120) and the distribution channel (122) are formed in the endpiece receiving element (112) and all directional changes inside the fluid channel are smaller than 90°. The filter arrangement (570) comprises a fluid supply line (574), a fluid discharge line (576), a flow channel (587), and a planiform filter element (580, 581, 582), the cross-sectional surfaces of said filter element being essentially the same size.

The invention relates to a nozzle arrangement for applying fluid containing solid particles to a substrate that is movable relative to the nozzle arrangement, having an endpiece receiving element and an endpiece attached to it, there being a fluid channel formed in the nozzle arrangement which has a connecting channel that may be connected to a fluid supply line, a distribution channel that connects downstream, and an outflow channel connecting still further downstream that leads into a fluid outflow slit. The invention also relates to a system for applying fluid containing particles to a substrate, having such a nozzle arrangement and having a transport device arranged to produce a relative motion between the nozzle arrangement and the substrate. Finally, the invention relates to a filter arrangement for use in such a system.

Such arrangements and systems are used to apply various fluid materials such as (molten) glues, paints, lotions or coating materials continuously or intermittently in the form of beads, lines, dots, or over an entire surface. Such a system includes a source of fluid, for example a (heated) glue reservoir, or is connected to such a source, from which the fluid is transported through the filter arrangement, possibly by means of a pump belonging to the system, and a connecting hose connected downstream which also belongs to the system and is heated if necessary. The connecting hose connects this so-called (melting and) transporting device to a so-called applicator head located downstream, which contains the fluid supply line, a valve arrangement connected to the fluid supply line, and the nozzle arrangement. The fluid stream can be interrupted or released by the valve arrangement. When the valve is open the fluid flows through the filter arrangement, the connecting hose, the fluid supply line and the fluid channel located in the nozzle arrangement, and emerges from the fluid outflow slit under pressure. In this way the fluid is applied to the substrate, which is moved relative to the nozzle arrangement—and more precisely relative to the fluid outflow slit—with the help of the transport device. With some of these systems the nozzle arrangement is in contact with the substrate while the fluid is being applied (contact type), whereas with other devices a gap is maintained between the nozzle arrangement and the substrate.

In various branches of industry, coating powders are becoming increasingly important. For example, thermally activatable powders, wettable powders or superabsorbent powders are used frequently in the area of hygiene articles such as diapers, napkins, hospital laundry or other sanitary articles, in the clothing industry, for household textiles such as carpets, wall coverings, upholstery fabrics, etc., as so-called “filled lotion” or “peeling” in the cosmetics industry, in the production of coated filters and for many other products. In principle such powders may be applied in the form of mixtures with a liquid carrier substance. The known application systems are unsuitable for applying such fluids containing solid particles, however, since the fluids containing solid particles show a tendency to separate, which leads to accretion of the particles at various places in the known application systems. Accretions are also the chief problem with automatic application of ointments (such as zinc ointments) or similar (pasty) fluids with solid components. This causes these systems to tend to become plugged at the corresponding locations within a very short time (fractions of milliseconds), as a result of which application of fluids containing solid particles becomes totally impossible, or at least the application pattern is untidy and/or unusable.

The object of the present invention is accordingly to create a system, a nozzle arrangement and a filter arrangement that solve the named problems in applying fluids containing solid or powdery particles.

This problem is solved by a nozzle arrangement of the type named at the beginning, where the connecting channel and the distribution channel are at least partially formed in the endpiece receiving element and where all changes of direction within the fluid channel are smaller than 90°.

This invention is based on the knowledge that the powdery, solid particles preferably accrete at the places in the nozzle arrangement at which turbulence occurs due to a severe change of velocity. Separation of the solid particles from the fluid and their accretion is avoided in the device according to the invention by the fact that care is taken to ensure an essentially lineal flow without severe changes of direction and hence of velocity. That means on the one hand that within the individual segments of the fluid channel, namely the connecting, distribution and outflow channel, as well as at the transitions between these zones, only angles of deflection that are smaller than 90° occur. Depending on the viscosity of the fluid, all angles of deflection are preferably in a range below 45°, and especially preferably below 25°. The laminar flow which is ensured to the maximum degree by this measure prevents separation of the solid particles and the fluid.

Preferably, the distribution channel is formed as a hopper which has a floor that is aligned with the connecting channel or inclined by less than 90° from the central axis of the latter and has at least one circumferential surface, with the floor and the at least one circumferential surface merging into each other in the form of radiuses. Again depending on the viscosity of the fluid, the angle between the floor and the central axis of the connecting channel is preferably less than 45° and in some cases less than 25°.

Preferably, the distribution channel tapers continuously in the direction of flow, viewed in the sectional plane perpendicular to the fluid outflow slit, and expands continuously viewed perpendicular to the above, the cross section of the distribution channel being substantially constant. This measure ensures that the fluid becomes distributed in the desired direction—namely in the direction of the fluid outflow slit—transversely to the direction of flow, while the speed of flow does not decrease because of the constant cross section. In addition to uniform distribution of pressure over the entire width of the outflow slit, this has the advantage that in contrast to an abrupt or discontinuous expansion on the one hand no dead cavities occur in which the solid particles can be deposited. On the other hand there are also no places with reduced flow velocity, in which the solid particles also preferably accrete.

In another preferred embodiment the floor and the at least one circumferential surface of the distribution channel are polished. This reduces the surface roughness and also lowers the tendency to accretion.

In another preferred embodiment, the endpiece has a contact surface for introducing the substrate, which is bounded on one side by the fluid outflow slit, there being an acute angle between the central axis of the outflow channel and the contact surface in the area of the fluid outflow slit, viewed in the plane perpendicular to the fluid outflow slit.

The tendency of the solid particles to accrete at places of severe change of speed normally causes small lumps of material to build up at the outflow slit, where the fluid can adhere because of its surface tension and where the velocity of flow consequently slows, which fall off uncontrolled and at irregular intervals. This causes a non-uniform application pattern. If the nozzle arrangement is rotated so that the direction of flow of the fluid in the outflow channel acquires a component in the direction of the (relative) motion of the substrate, the change of velocity between the outflow and the deposition on the substrate surface (application) of the fluid is smaller than with known nozzle arrangements whose outflow channel is at an angle of 90° to the substrate surface. To state it differently, the angle of deflection of the fluid stream at emergence/application is also smaller than 90°. As a result, the flow of fluid is less severely hindered compared to the devices known heretofore from the existing art, so that a buildup of material at the outflow slit is prevented.

In the last-named embodiment of the invention this is taken into account by the fact that the angle between the central axis of the outflow channel and the contact surface in the area of the fluid outflow slit is not 90°, as in the known nozzle arrangements or endpieces, but is reduced by the amount of the angle of rotation of the nozzle arrangement, so that the contact surface adjacent to the fluid outflow slit is in tangential contact with the substrate in the area of the fluid outflow slit, for the purpose of contact application.

Another improvement of the nozzle arrangement according to the invention in regard to the described problems is achieved by the fact that the nozzle arrangement has a pressurized gas channel that is connectable to a source of pressurized gas and leads to a gas outflow orifice; this pressurized gas channel is positioned on the side of the fluid channel away from the contact surface, so that a stream of gas emerging from the gas outflow orifice flows toward the fluid outflow slit in such a way that any fluid which may collect on an outer surface of the nozzle arrangement located on a side of the fluid channel facing away from the contact surface is struck by the stream of gas.

The last-named measure also works contrary to the adhesion of the fluid, and thus provides for uniform flow of the fluid until it is deposited on the surface of the substrate. This is even more effective in preventing soiling or (partial) blockage of the fluid outflow slit and an uneven application pattern.

The above-named problem is further solved by a system of the type named at the beginning having one of the nozzle arrangements mentioned above, in which an angle between the central axis of the outflow channel of the nozzle arrangement and the transport direction of the transport device on the run-out side of the fluid outflow slit, viewed in the sectional plane perpendicular to the fluid outflow slit, is obtuse.

If the angle between the central axis of the outflow channel and the substrate on the run-out side of the fluid outflow slit, i.e. on the side of the outflow channel away from the contact surface, is enlarged, the result described above is achieved: The direction of flow of the fluid in the outflow channel then acquires a component in the direction of the relative motion between the nozzle arrangement and the substrate. This has the effect of reducing the change of velocity between the emergence and the application of the fluid.

And the problem named above is solved by a filter arrangement for use in such a system, having a fluid supply line, a fluid drain line, a flow channel connecting the fluid supply line and the fluid drain line and a planiform filter element positioned in the flow channel, with the cross sectional areas of the fluid supply line, the fluid drain line, the flow channel and the filter element being essentially of equal size.

Filter arrangements that have cylindrical filter elements with an axial inlet are known from the existing art. There the fluid flows through a constricted cross section into the interior of the filter, and after being redirected it emerges in the radial direction through the cylindrical circumferential surface. This permits a comparatively large filter surface with relatively compact construction, but it also always means an enlargement of the cross section through which the fluid flows. The velocity of flow is consequently reduced both in the interior and outside of the filter, and the solid particles can become deposited in the flow channel through the filter or through a filter housing surrounding the filter, preferably in dead cavities and corners, for the reasons stated above.

By preference, in the filter arrangement there are a plurality of planiform filter elements positioned in the flow channel, with mesh size decreasing in the direction of flow.

Such an arrangement is known from screening technology, in which the serial arrangement of various screens serves to separate granular bulk goods into different size fractions. In contrast, the arrangement of the present invention works to counter the problem that by avoiding enlargement of the cross sectional area the filter area is intentionally reduced compared to the known cylindrical filters. The resulting reduction in the service life of the filter is at least partially compensated for according to the invention by the fact that the mesh size of the filter elements positioned one after another in the direction of flow decreases, namely in such a way that depending on the filtrate an approximately equal quantity of filter cake is separated out at each of the filters.

Fortunately the course of the flow channel is essentially linear, and the surface of the filter element is perpendicular to its direction of flow.

Because of the linear flow direction there is no need to deflect the fluid to a radial direction. This prevents accretion of the solid particles in the area of the flow channel through uniform flow velocity. This effect is reinforced by the fact that the fluid can flow straight through the filter element, which is perpendicular to the direction of flow—in contrast to the filter arrangements with cylindrical filter elements, known from the existing art.

Additional functions, features and advantages of the invention will now be explained in greater detail on the basis of an exemplary embodiment with the help of the drawing. The figures show the following:

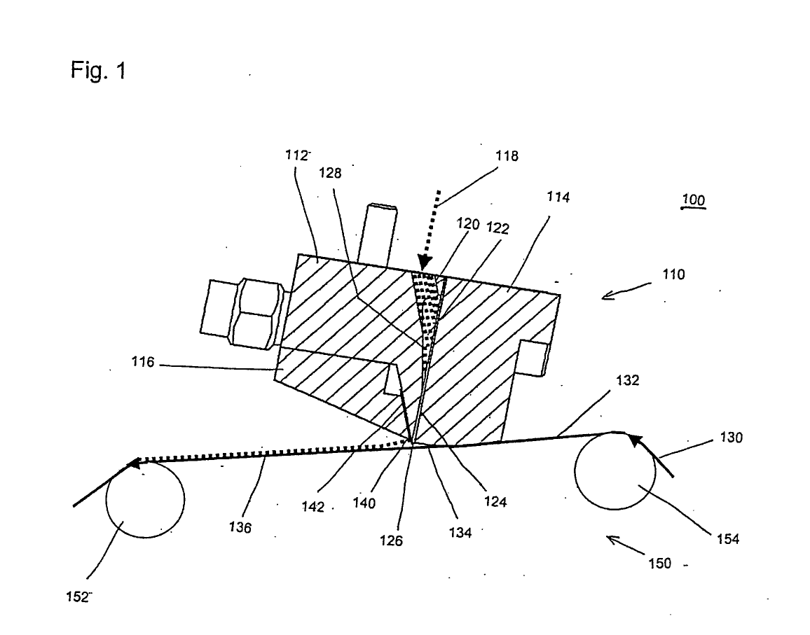

FIG. 1: a sectional view of an embodiment of the system according to the invention, having a nozzle arrangement and a transport device in the plane perpendicular to the outflow gap;

FIG. 1A: a sectional view of the nozzle arrangement according to the embodiment from FIG. 1;

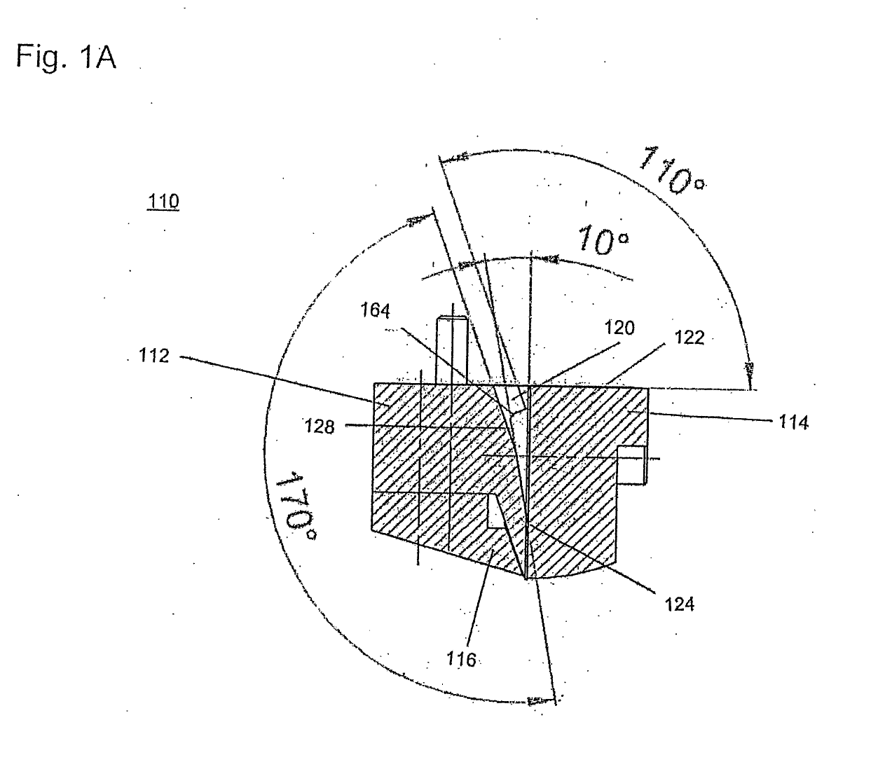

FIG. 2: a front view of a first exemplary embodiment of the nozzle arrangement according to the invention;

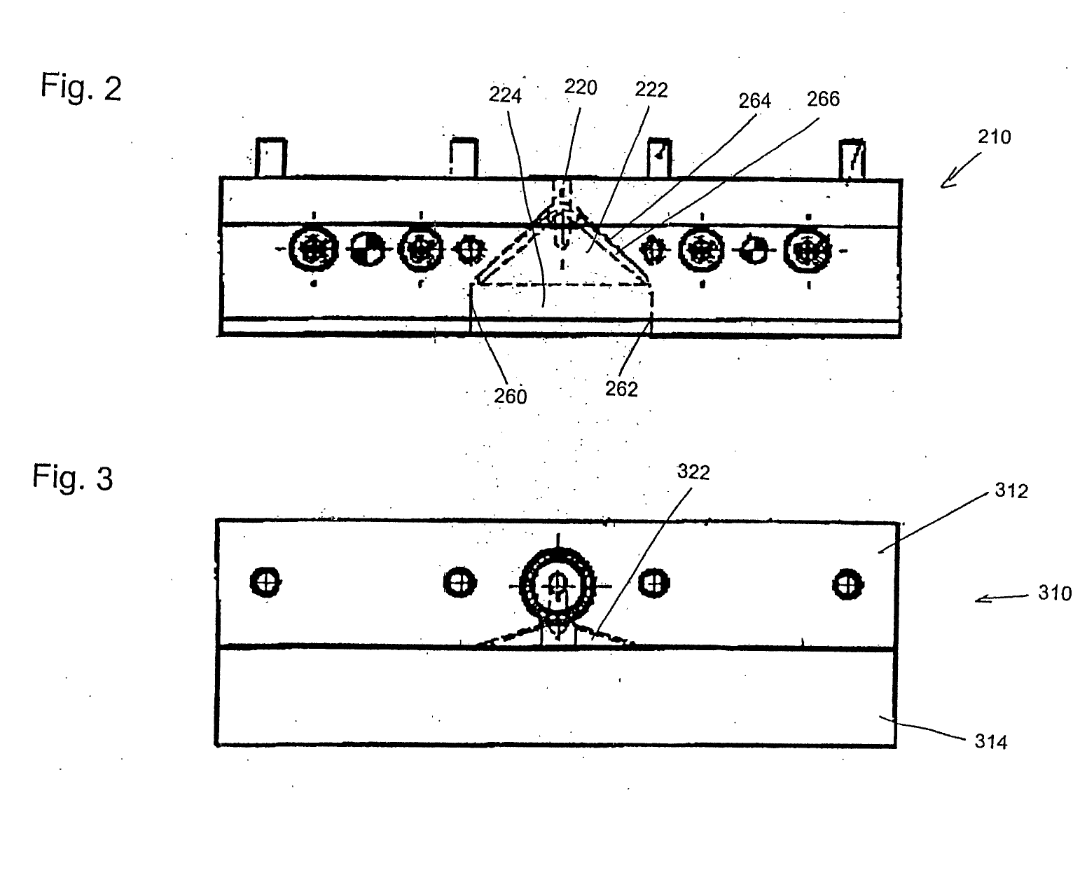

FIG. 3: a top view of the nozzle arrangement from FIG. 2;

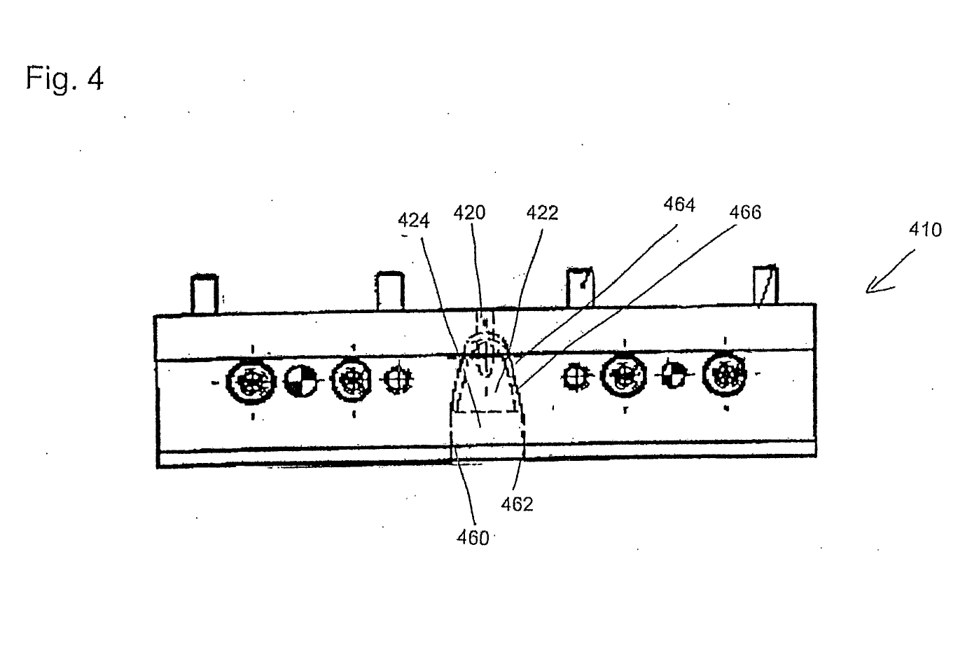

FIG. 4: a front view of a second exemplary embodiment of the nozzle arrangement according to the invention;

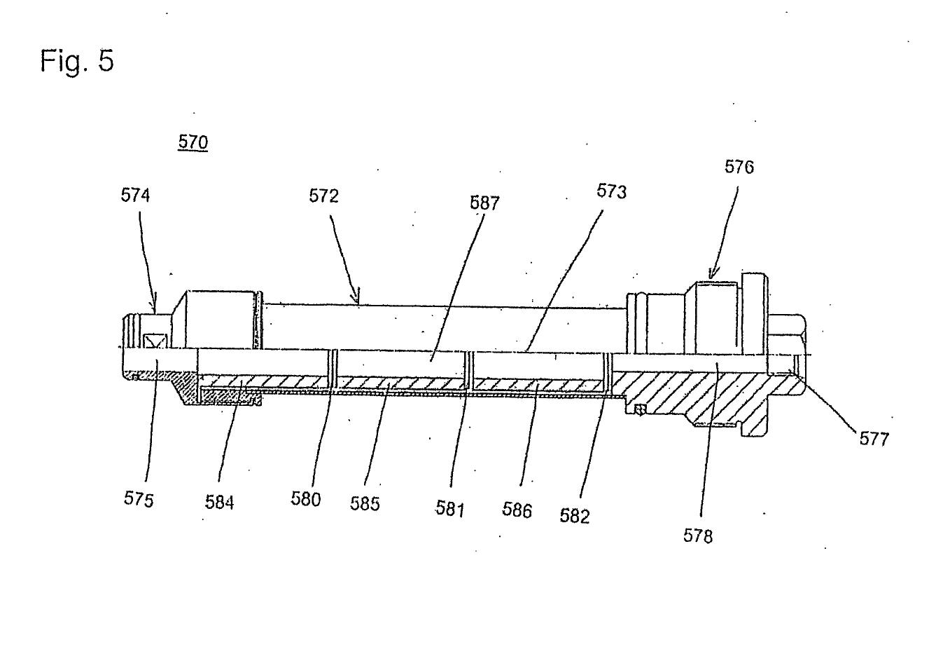

FIG. 5: a partial sectional side view of an embodiment of the filter arrangement according to the invention; and

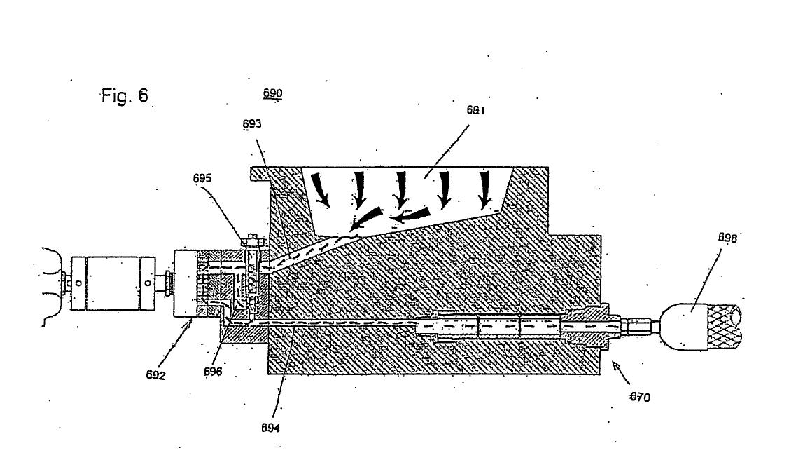

FIG. 6: a sectional side view of the filter arrangement according to FIG. 5, installed in a melting and transport apparatus of the system according to the invention.

The system 100 shown in FIG. 1 has a nozzle arrangement 110 according to the invention and a transport apparatus 150. The nozzle arrangement 110 is made up of an endpiece receiving element 112, an endpiece 114 and a nozzle piece 116. A fluid 118, for example a (molten) glue, paint, a lotion or other coating agent in liquid form mixed with solid particles, is fed to nozzle arrangement 110 by means of a fluid supply system (not explained in further detail). This fluid supply system communicates with a fluid channel formed in the nozzle arrangement, which includes a plurality of segments: a connecting channel 120 that is connected to the fluid supply system, a distribution channel 122 that connects downstream, and an outflow channel 124 having a flow connection with the latter downstream, which leads to a fluid outflow slit 126.

The connecting channel 120 is formed by an oblique through bore in the endpiece receiving element 112; see also FIG. 1A. The through bore itself has no change of direction. The distribution channel 122 in the exemplary embodiment from FIG. 1 is designed in the form of a hopper, completely in the endpiece receiving element 112. Alternatively, the distribution channel can also for example be formed half in the endpiece receiving element and half in the endpiece. The hopper is deeper in the area of the mouth of connecting channel 120, and expands in a wedge shape—bounded on one side by a floor 128 that runs obliquely to the boundary surface between the endpiece receiving element 112 and the endpiece 114—in the direction of outflow channel 124. The transition between connecting channel 120 and distribution channel 122 is nearly flush, and the floor also has no bends and hence no deflection of the flow of fluid in the plane shown in FIGS. 1 and 1A. The angle between the central axis of connecting channel 120 and the floor 128 of distribution channel 122 is only 100 in the exemplary embodiment shown.

The wedge shape of distribution channel 122 reduces its cross section in the view shown in FIG. 1. As can be seen in FIGS. 2 and 4, which show two different exemplary embodiments of a nozzle arrangement in a view perpendicular to the one above, the distribution channel—bounded by a circumferential surface 164, depending on the application width desired—widens out to a greater or lesser degree in the direction of the fluid outflow slit 126, which runs perpendicular to the plane of representation or the sectional plane. By adjusting the depth of the hopper, the cross section of distribution channel 122 can be kept essentially constant, which ensures uniform speed of flow of the fluid in the fluid channel. Both the tapering shown in FIG. 1 and the widening of the distribution channel recognizable in FIG. 2 and 4 are continuous, so that dead cavities that occur with abrupt or uneven widening and in which particles can collect are prevented.

Furthermore, the speed of flow of the fluid can be optimized by tuning the cross section of connecting channel 120 to that of distribution channel 122.

Outflow channel 124 is formed on the boundary surface between endpiece receiving element 112 and endpiece 114. It is formed by a clearing extending downward from a lower segment of distribution channel 122. This can be for example in the form of a spacer sheet inserted between endpiece receiving element 112 and endpiece 114, or may be integrated into endpiece receiving element 112 or into endpiece 114 by an appropriate milling. The clearing has an overlap with the distribution channel 122 formed in endpiece receiving element 112, through which the fluid 118 flows. The outflow channel 124 is bounded laterally in the plane perpendicular to the illustrated sectional plane by two edges 260, 262 or 460, 462 of the clearing, and thereby defines the width of the fluid outflow slit 126; see FIGS. 2 and 4.

The outflow channel runs completely straight, and also the transition from the distribution channel 122 to the outflow channel has only a slight change of direction. The angle between the floor 128 of the distribution channel 122 and the outflow channel 124 is only 10°. Accordingly, the connecting channel 120, the distribution channel 122 and the outflow channel 124 themselves have no deflections, and are also positioned with respect to each other so that the stream of fluid overall undergoes no deflection greater than 25°.

FIG. 1 also shows a substrate 132, which is brought to the nozzle arrangement 110 in the transport direction 130 and is touching the nozzle arrangement 110. Accordingly, this is a contact type application system. For this purpose there is a contact surface 134 on the endpiece 114. The latter has a radius in the plane of representation whose tangent at the point of the fluid outflow slit 126 is at a right angle to the central axis of the outflow channel 124.

Whereas in the known application systems the nozzle arrangement 110 is positioned vis-a-vis the substrate 132 in such a way that the outflow channel is upright over the surface of the substrate, the system according to the invention has an inclination of the outflow channel 124 of the nozzle arrangement 110 from the vertical direction onto the transport path of the substrate 132. In the exemplary embodiment shown, the angle of inclination is 10°. On the one hand that produces an oblique angle between the central axis of the outflow channel 124 and the substrate surface 132 on the side of the fluid outflow slit 126 opposite the contact surface 134 (the run-out side). On the other hand, the fluid outflow slit 126 is raised from the substrate surface 132. Both effects result in preventing accretion of particles in the area of the fluid outflow slit 126, in part because the deflection of the fluid stream indicated by a dotted line 135 (see FIG. 1) does not take place at a right angle, as known from the existing art, but at a small angle of deflection. In addition, the fluid outflow slit 126 is not blocked by the surface of the substrate 132, which is otherwise in direct contact.

To support the prevention of accumulation of fluid and in particular of the solid particles during application, the nozzle piece 116 of nozzle arrangement 110 also has a pressurized gas channel 142, which can be connected to a pressurized gas source (not shown) and leads to a gas flow orifice 140 in the form of a slit. The pressurized gas channel is oriented so that a stream of gas flowing from gas outflow orifice 140, preferably a stream of air, flows to the fluid outflow slit 126 in such a way that no fluid can cling by adhesion to the side of the fluid outflow slit facing away from the contact surface 134. Fluid that emerges from the fluid outflow slit is caught by the gas flow and constantly led away from an outer surface of the nozzle arrangement located on this side of the fluid outflow slit, in the direction of the substrate surface 132. So it never gets to the point where small lumps of material build up and fall off.

The exemplary embodiment of the system according to the invention from FIG. 1 has two rollers 152, 154, over whose circumferential surfaces the substrate, which is positioned on a transport belt, is fed. The design of transport device 150 is not important for the system according to the invention, however. Alternatively, instead of the rollers 152, 154 there can also be for example a movable stage or any other transport device.

Furthermore, the contact surface 134 can also be designed so that the radius is in contact with the substrate surface 132 tangentially in the area of the fluid outflow slit 126. This makes the angle between the contact surface 134 in this area and the central axis of the outflow channel acute. With this exemplary embodiment too, the deflection of the stream of fluid at the transition to the substrate remains smaller than 90°. This measure ensures a nozzle arrangement of the contact type, in which the contact of the outflow channel or outflow slit with the substrate is ensured; this can be advantageous, depending on the viscosity of the fluid.

FIGS. 2 and 3 show nozzle arrangement 210 or 310, consisting of endpiece receiving element 312 and endpiece 314 again in a front view (FIG. 2) and a top view (FIG. 3). In the front view the path of the connecting channel 220, the distribution channel 222 and the outflow channel 224 are shown with dashed lines. A double line is used to indicate that a circumferential surface 264 that bounds the distribution channel 222 on top and on the sides merges into the floor 128 (not recognizable in the representations in FIGS. 2 and 3) with a radius 266. This avoids angular transitions that represent cavities in which particles can collect. Outflow channel 224 is bounded on the top by the already mentioned edges 260, 262 or 460, 462 of the clearing, which is incorporated into the spacer sheet, the endpiece or the endpiece receiving element. This defines the width of the outflow channel 224 and the fluid outflow slit 126.

The embodiment of nozzle arrangement 410 shown in FIG. 4 is identical in principle with the embodiment shown in FIG. 2. The only difference consists in a smaller application width, which is guaranteed by a narrower distribution channel 422 and by a narrower outflow channel 424, which is bounded by the two edges 460, 462. The exemplary embodiment shown in FIG. 4 also has a circumferential surface 464 of distribution channel 422, which merges into the floor of the distribution channel in the form of a radius 466.

The nozzle arrangement according to the invention is not limited to these exemplary embodiments. For example, instead of the continuous clearing shown in the spacer sheet or milling in the endpiece or in the endpiece receiving element, a comb-like structure can also be provided. Instead of one outflow channel this forms a number of outflow channels positioned adjacent to each other, which lead to fluid outflow slits arranged accordingly adjacent to each other.

The exemplary embodiment of a filter arrangement 570 according to the invention shown in FIG. 5 as a half sectional view includes a cylindrically symmetrical housing 572 with a main direction of extension along the cylindrical axis 573. At its one axial end the housing 572 has a radially sealed inlet fitting 574 as the fluid supply line, with an inlet bore 575 aligned coaxially to the cylinder axis 573. At the opposite end of the housing 572 there is an outlet fitting 576, also radially sealed, as the fluid drain line, with a threaded fitting 577 as the connecting element. The outlet fitting 576 and the threaded fitting 577 have a tap hole 578, which is also aligned coaxially to the cylindrical axis 573 of the housing 572. Because of the coaxial arrangement of the fluid supply line 574, the housing 572 and the fluid drain line 576, the direction of flow inside the filter arrangement 570 is entirely linear. Furthermore, there are no constrictions of the cross section worth mentioning, so that turbulence and changes of speed of the fluid flowing through the filter arrangement 570 are for the most part prevented. This suppresses any accretion of solid particles.

In the exemplary embodiment shown there are a total of three planiform filter elements or disks 580, 581, 582 located in the housing 572. The surfaces of the filter disks are perpendicular to the cylindrical housing 573 and thus to the direction of flow of the fluid. This measure also has the effect that no deflection of the flow takes place. The filter disks 580 preferably have a ring-shaped carrier frame and filter fabric attached to it or stretched within it as the filter medium. With the arrangement of a plurality of such filter disks 580, 581, 582 shown in FIG. 5 it proves to be advantageous to decrease the mesh size of the fabric from one filter disk to the next in the direction of flow. The graduation is preferably accomplished, with attention to the grain size of the particles, in such a way that about the same quantity of impurities or particles that are to be filtered out with too great a grain size are separated out at each of the filter disks. This makes it possible to increase the service life of the filter arrangement as a whole.

The filter disks 580, 581, 582 are arranged with even spacing in the housing 572 by means of spacer sleeves 584, 585, 586. After the inlet fitting 574 is removed, the spacer sleeves and the filter disks can be taken out of the housing 572 for the purpose of cleaning or replacing them. By using spacer sleeves of different lengths it is possible to position one, two or more filter disks in the housing 572 at the same or different intervals.

In FIG. 6 the filter arrangement 670 from FIG. 5 is employed in an exemplary system according to the invention to apply fluid containing solid particles. Stated more precisely, the arrangement shown is a melting and transport device 690 belonging to the system. In the melting and transport device 690, hot melt adhesive that is introduced into a tank segment 691 in the form of granulate or chunks is melted and transported in the direction of the filter arrangement 670 by means of a pump 692 (for example a gear pump) driven by a motor. A valve 695 and a bypass line 696 are connected between a suction line 693 that connects the tank 691 and the pump 692 and a pressure line 694 that connects the pump 692 and the filter arrangement 670. The valve 695 can be used to set the maximum pressure of the fluid, at which the bypass line 696 is opened.

The pressure line 694 is oriented parallel to the filter arrangement 670, so that there is also no deflection of the flow of fluid produced in the transition from the pressure line to the filter arrangement. In contrast to the exemplary embodiment shown in FIG. 6, it proves to be advantageous to arrange the pressure line 694 in such a way that it is flush with the underside of the inlet bore 575 of the inlet fitting 574, so that no solid particles can collect due to gravity in a cavity which would otherwise be formed. In another preferred exemplary embodiment the pressure line 694 has the same cross section as the inlet bore 575, at least in the area of the fluid supply line 574 of the filter arrangement 670 which is connected to it.

This can be achieved either by continuously enlarging pressure line 694 along the direction of flow to this cross section, or by the pressure line 694 having the same cross section throughout as the inlet bore 575 of the filter arrangement 670. In both cases there is no abrupt drop in the speed of flow at the transition from the pressure line to the filter arrangement, and the tendency for the fluid to separate and for the solid particles to deposit is reduced.

On the outlet side, a connecting hose 698 is connected to the fluid drain line 576 of the filter arrangement 670 by means of the threaded fitting 577. The latter connects the filter arrangement 670 with the nozzle arrangement according to the invention. Normally there are additional connecting elements connected between the connecting hose 698 and the nozzle arrangement. These contain valves for controlling the application process, as well as a fluid supply line that communicates with both the connecting hose 698 and the connecting channel of the nozzle arrangement. In the case of this system the connecting hose 698 can be heated for applying a hot melt adhesive, so that the optimal processing temperature and flow properties are maintained along its transport path from the melting and transport device 690 to the nozzle arrangement.

1-16. (canceled)

17. A nozzle arrangement for applying fluid containing solid particles to a substrate moving relative to the nozzle arrangement, comprising:
an endpiece;
an endpiece receiving element operatively coupled to said endpiece; and
a nozzle piece operatively coupled to said endpiece receiving element;
said endpiece, endpiece receiving element, and nozzle piece together defining a fluid channel, said fluid channel including a connecting channel, a distribution channel, and an outlet channel, said connecting channel having a first longitudinal axis, said distribution channel having a second longitudinal axis, and said outlet channel having a third longitudinal axis, and said outlet channel terminating in a fluid outflow slit, wherein said second longitudinal axis has a change in directional orientation relative said first longitudinal axis less than about 90°, and wherein said third longitudinal axis has a change in directional orientation relative said second longitudinal axis less than about 90°.

18. A nozzle arrangement according to claim 17, wherein said second longitudinal axis of said distribution channel extends at an angle between about 5° and about 25° relative said first longitudinal axis of said connecting channel.

19. A nozzle arrangement according to claim 17, wherein said distribution channel further includes an entrance, an exit, and a length defined therebetween, wherein cross sectional areas of said distribution channel along said length of said channel from said entrance to said exit converge along a first channel dimension and expand along a second channel dimension substantially perpendicular to said first channel dimension resulting in a substantially constant cross sectional area of said distribution channel.

20. A nozzle arrangement according to claim 17, wherein said endpiece further includes a contact surface for contacting said substrate, said contact surface bound on one side by said fluid outflow slit.

21. A nozzle arrangement according to claim 20, wherein an angle between said third longitudinal axis of said outlet channel and said contact surface proximate said fluid outflow slit is acute.

22. A nozzle arrangement according to claim 17, further comprising a pressurized gas channel that is connectable to a source of pressurized gas and operative to direct pressurized gas towards said fluid outflow slit for removing fluid collected proximate said fluid outflow slit.

23. A system for applying fluid containing solid particles on a substrate comprising:
a nozzle arrangement, including:
an endpiece;
an endpiece receiving element operatively coupled to said endpiece; and
a nozzle piece operatively coupled to said endpiece receiving element;
said endpiece, endpiece receiving element, and said nozzle piece together defining a fluid channel, said fluid channel including a connecting channel, a distribution channel and an outlet channel, said connecting channel having a first longitudinal axis, said distribution channel having a second longitudinal axis; and said outlet channel having a third longitudinal axis, said outlet channel terminating in a fluid outflow slit, wherein said second longitudinal axis has a change in directional orientation relative said first longitudinal axis less than about 90°, and wherein said third longitudinal axis has a change in directional orientation relative said second longitudinal axis less than about 90°; and
a transport device configured to produce a relative motion between said nozzle arrangement and the substrate along a transport direction, said third longitudinal axis and said transport direction defining an obtuse angle therebetween.

24. A system according to claim 23, further comprising a fluid supply line, a fluid drain line, a flow channel connecting said fluid supply line and said fluid drain line and a filter arrangement having a planiform filter element positioned in said flow channel, wherein cross sectional areas of said fluid supply line, said fluid drain line, said flow channel and said filter element are essentially of equal size.

25. A system according to claim 23, wherein said flow channel has an essentially linear path and a surface of said filter element is transverse to a flow direction of said flow channel.

26. A system according to claim 25, further comprising a plurality of planiform filter elements having a decreasing mesh size in a flow direction, said plurality of planiform filter elements positioned inside said flow channel.

27. A filter arrangement comprising:
a fluid supply line;
a fluid drain line;
a flow channel connecting said fluid supply line and said fluid drain line; and
a planiform filter element positioned in said flow channel, wherein cross sectional areas of said fluid supply line, said fluid drain line, said flow channel, and said planiform filter element are essentially of equal size.

28. A filter arrangement according to claim 27 wherein said planiform filter element further comprises a plurality of planiform filter elements positioned generally perpendicular to said flow channel and having decreasing mesh size in a direction of flow in said flow channel.

29. A filter arrangement according to claim 28 wherein said planiform filter elements include a filtering surface and said filtering surface is oriented generally perpendicular to the direction of flow.
